(19) United States
(12) Patent Application Publication
(10) Pub. No.: US 2011/0056407 A1
(43) Pub. Date: Mar. 10, 2011

(54) AMUSEMENT DEVICE AND PROPELLING METHOD FOR PROPELLING A PASSENGER CARRIER OF SUCH AMUSEMENT DEVICE

(75) Inventors: Joop Roodenburg, Delft (NL); Cornelis Johannes Ekelaar, Rotterdam (NL)

(73) Assignee: VEKOMA RIDES ENGINEERING B.V.

(21) Appl. No.: 12/934,584

(22) PCT Filed: Mar. 26, 2008
(86) PCT No.: PCT/NL08/00092

§ 371 Date: Nov. 24, 2010

(51) Int. Cl. A63G 7/00; H02J 7/00; B61C 3/00

(52) U.S. Cl. 105/49; 320/167

(57) ABSTRACT

An amusement device comprises a passenger carrier and a propelling system for propelling the passenger carrier. The propelling system comprising an electric motor for propelling the passenger carrier, and a power supply to power the electric motor. The power supply comprises an electrical storage element to store electrical energy. The control unit is arranged to control the power supply such as to operate the power supply to charge the electrical storage element from a power source; and to operate the power supply to power the electric motor from the electrical energy stored in the electrical storage element, to thereby propel the passenger carrier.

The invention relates to an amusement device having a passenger carrier and a propelling system for propelling the passenger carrier, and to a propelling method for propelling a passenger carrier in an amusement device.

In amusement devices, various propelling systems are known. It is for example known to propel a passenger carrier by a hydraulic system. At a start of a trajectory, the passenger carrier is thereby propelled to a certain speed, allowing the passenger carrier to follow the trajectory until an end thereof. Next to hydraulic systems, many other propelling systems are known: as an example, a linear motor may be provided to accelerate the passenger carrier to a certain speed, the passenger carrier thereby e.g. being unable to travel a remainder of the trajectory of the amusement device on its own. Many other configurations are possible: the motor may for example be comprised in the passenger carrier, and be provided with electrical power via sliding contacts.

A general trend in amusement device is towards high velocities, high thrill and maximum sensation, which results in a high power need to enable to achieve a correspondingly high acceleration of the passenger carrier. Hydraulic systems are thereby put to their limit due to inherent inertia of hydraulic systems and due to an occurrence of a high power dissipation in hydraulic systems when attempting to increase forces to be applied to the passenger carrier to achieve correspondingly high accelerations. Secondly, hydraulic systems, especially in the demanding applications of today's amusement devices, will exhibit a high need for maintenance, thereby possibly resulting in an increased costs of ownership, a risk of down time due to repairs etc.

When making use of electrical propelling systems, limitations occur in the amount of power to be drawn from a power supply, such as a mains supply. Power problems may even be increased in that accelerations and propelling of the passenger carrier is to take place with an intermitted time pattern, e.g. to achieve spectacular, sudden acceleration effect, which may result in high peak demands of electrical power. The combination of high power consumption and power demand in peaks may result in a power consumption pattern which is not acceptable for a supplier, e.g. an operator of a mains network. Also, generators such as diesel generators are not able to cope with such sudden fluctuations in demand.

As a consequence, both hydraulically driven propelling systems as well as electrically driven propelling systems may run into limitations when attempting to achieve high accelerations of the passenger carrier in an amusement device.

The invention intends to provide a versatile propelling arrangement for a passenger carrier of an amusement device.

Thereto, according to an embodiment of the invention, there is provided an amusement device having a passenger carrier and a propelling system for propelling the passenger carrier, the propelling system comprising an electric motor to propel the passenger carrier, a power supply to power the electric motor, the power supply comprising an electrical storage element to store electrical energy, and a control unit which is arranged to control operation of the power supply, the control unit being arranged to:
operate the power supply to charge the electrical storage element from an power source; and
operate the power supply to power the electric motor from the electrical energy stored in the electrical storage element, to thereby propel the passenger carrier.

The storage element is thus charged from an external power source, and then the electric motor of the propelling system is powered from the electrical energy stored in the storage element, to thereby propel the passenger carrier. The charging of the electrical storage element may take place in a time period which is comparatively long with respect to the time period during which the propelling of the passenger carrier takes place, i.e. the time during which the electric motor is operated. The electric motor may comprise any type of electric motor, e.g. a rotating motor, a linear motor, a stationary magnet motor, a stationary coil motor, a direct current motor, an alternating current motor etc. The power supply may comprise any suitable type of power supply: it is for example possible that the power supply comprises an inverter to drive the motor, or any other suitable circuit in order to power the motor. The power supply may further comprise any suitable charging arrangement for charging the electrical storage element, some examples of which may include a switch to connect the electrical storage element to the external power source for charging, a rectification circuit in case of an alternating current external power source, in a preferred embodiment, the power supply however comprises a converter to convert electrical energy into a charging voltage for charging the storage element, and visa versa to allow the storage element to be used over a wide operating range, such as a wide operating voltage range, thereby possibly increasing an energy storage capacity thereof. The converter may e.g. comprise a bidirectional direct current-direct current converter or any other suitable conversion circuit.

The storage element my comprise any type of electrical storage element, in a preferred embodiment, the electrical storage element comprises a capacitor, more preferably a super capacitor, thereby allowing to store a relatively large amount of energy in a relatively small volume, and allowing to charge respectively discharge the super capacitor with a high electrical current, thereby enabling to operate the motor at a high power, and allowing high accelerations of the passenger carrier. Furthermore, by making use of a super capacitor, a quick charging an/or discharging (resulting in a high number of motions per time unit), a high power efficiency, a long operating life and/or other advantages may be provided.

In a preferred embodiment, in case that the storage element comprises a plurality of capacitors, the converter may comprise a switching network to switch the capacitors in series and/or parallel combinations. Thereby, a charging or discharging voltage of may be adapted an operating voltage range of the (super) capacitors, which will allow to use the (super) capacitors in its operating voltage range, while providing more versatility in charging/discharging voltages. Furthermore, the switching can be performed in a relatively easy to implement way and with a low power loss.

In an alternative embodiment, the converter may comprise an inductor to form an inductor-capacitor resonance circuit with the super capacitor, a resonance frequency of the resonance circuit being adapted to a propelling time of the motor (e.g. an operation cycle time). The resonance frequency may e.g. be adapted by switching more of less capacitors into the circuit, e.g. in parallel and/or in series.

In a preferred embodiment, the control unit is arranged to measure an operating voltage of the electrical storage element and to connect an electrical power dissipator when the operating voltage of the electrical storage element exceeds a maximum operation voltage. Thereby, an over charging of the electrical storage element may be prevented.

The propelling system may be substantially stationary, i.e. form part of a non moving element of the amusement device as desired. In case the propelling system is mounted in the passenger carrier, any kind of suitable contacting may be provided to enable charging of the electrical storage element, e.g. by sliding contacts or by contacts at a predetermined location along a trajectory of the passenger carrier, to enable charging of the electrical storage element at that location (e.g. an entry/exit area where passengers embark respectively disembark the passenger carrier). When the propelling system is mounted in the passenger carrier, in a further advantageous embodiment, the motor comprises a motor-generator combination, the control system may thereby be adapted to control the power supply such as to charge the electrical storage element with electrical energy generated by the generator during a motion of the passenger carrier. Many applications are imaginable: in case for example that the passenger carrier is decelerated, energy can be regenerated by the generator and stored in the electrical storage element, to be used for a following acceleration of the passenger carrier.

According to an aspect of the invention, there is provided a propelling method for propelling a passenger carrier in an amusement device, wherein the passenger carrier is propelled by an electric motor, the electric motor being driven from an electrical storage element, the method comprising:
charging the electrical storage element from an power source; and
powering the electric motor from electrical energy stored in the electrical storage element, to thereby propel the passenger carrier. With the method according to the invention, similar advantages and effects may be achieved as with the method according to the invention. Furthermore, similar preferred embodiments are possible as with the amusement device according to the invention, thereby achieving same or similar effects.

The invention will further be explained with reference to the appended drawing, showing non limiting embodiments, wherein:

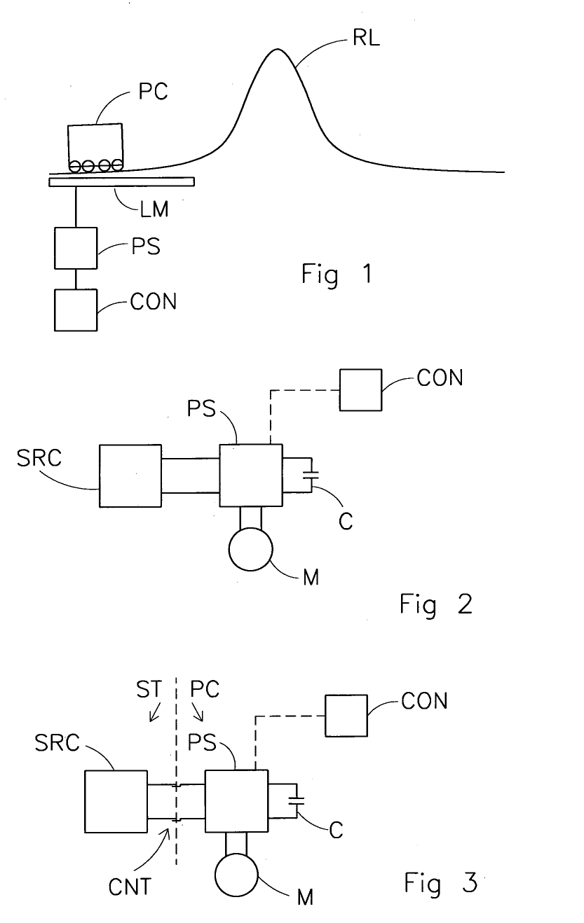

FIG. 1 shows a highly schematic diagram of an amusement device according to an aspect of the invention;

FIG. 2 shows a highly schematic diagram of a propelling system for an amusement device according to an aspect of the invention;

FIG. 3 shows another embodiment of a propelling device of an amusement device according to an aspect of the invention;

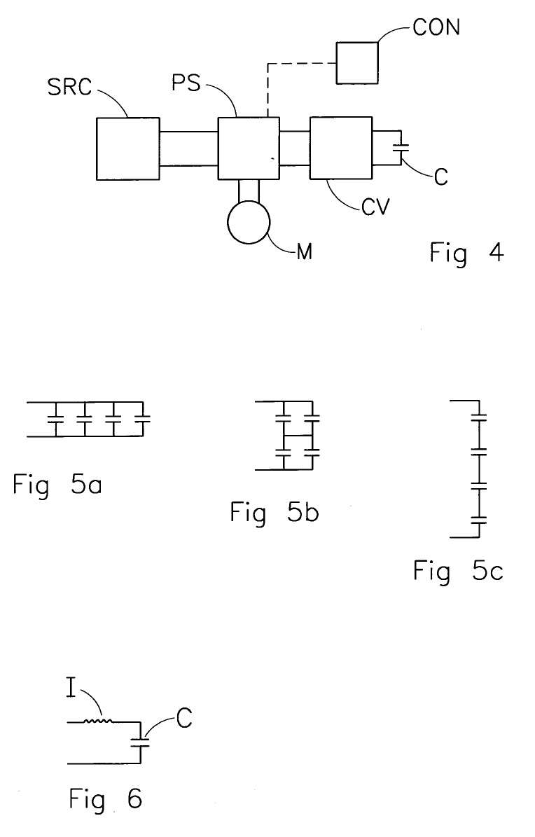

FIG. 4 shows yet another embodiment of a propelling system of an amusement device according to the invention;

FIG. 5 A-C show series and/of parallel connections of super capacitors of a propelling system according to an embodiment of the invention; and

FIG. 6 shows a schematic diagram of a resonance circuit of a propelling device according to an embodiment of the invention.

FIG. 1 shows a highly schematic representation of an amusement device comprising a passenger carrier BC and a rail RL along which it may be propelled. A propelling system is provided, comprising in this example a linear motor LM for driving the passenger carrier PC, a power supply PS for powering the linear motor, and a controller CON for controlling the power supply. The controller may control the power supply PS such as to drive the linear motor LM to accelerate the passenger carrier PC. The passenger carrier PC may then drive along the rail RL towards an end thereof on its own, i.e. making use of the kinetic energy provided to it by the propelling by the linear motor LM.

FIG. 2 depicts a highly schematic view of a propelling system of an amusement device according to an aspect of the invention, as well as an external power source. An electric motor M is powered by a power supply PS which is controlled by a controller CON. The power supply PS is provided with electrical energy by a power source SRC, such as a generator, or a mains power supply. An electrical storage element is comprised in the power supply PS, the electrical storage element being symbolically drawn in FIG. 2 and by capacitor C, such as a super capacitor. The control unit CON may control the power supply PS such as to charge the electrical storage element, i.e. the capacitor or super capacitor C from the power source SRC, and may control the power supply so as to power the electric motor from the electrical energy stored in the electrical storage element, to thereby propel the passenger carrier. As a result, a peak electric power demand from the power source SRC may be prevented, as the energy storage element may be charged by the power supply PS at a relatively low rate, thereby reducing a momentary power consumption from the power source SRC, while the motor can then by powered by the power supply making use of old energy stored in the storage element, to thereby allow operating the motor independently of the power source SRC and/or at a high momentary power. On the one hand, the motor may be driven independently of the power source SRC, thereby allowing e.g. a motor in the passenger carrier to propel the passenger carrier remotely from a contact area where contact with the power source SRC is made, on the other han, high momentary peak loads of the power source SRC may be prevented as the capacitor C may be charged at a relatively low charging rate, the charged capacitor being applied to power the motor, thereby enabling the motor to operate at momentary power levels which exceed a possible peak power delivery of the power source SRC. As an example, the capacitor C (e.g. super capacitor) could be charged in a time frame of several minutes, followed by a driving of the motor M with energy from the super capacitor, in a time frame of seconds. Thereby, a peak power to be provided by the power source SRC can be reduced significantly, as compared to the situation where the power source SRC would have to provide energy to the power supply PS instantaneously for operating the motor at the same peak load. As a result, acceleration levels may be achieved which could not have been achieved if the motor M would have been powered directly from the power source SRC, due to power limitations and peak limitations thereof. The motor M may comprise any type of motor, including a rotating motor, a linear motor, a stationary coil motor, a stationary magnet motor, an alternating current motor, a direct current motor, etc. The control unit may include any control unit such as a microcontroller, microprocessor, or any programmable device provided with suitable program instructions. The controller may control the power supply by any suitable means, i.e. by a data connection such as a parallel of serial database, control lines of in any other suitable way. The motor M may act on the passenger carrier in any suitable way, e.g. by driving wheels of the passenger carrier, by propelling the passenger carrier on a rail, by pulling or pushing the passenger carrier by any suitable means, etc.

FIG. 3 shows a possible embodiment of the propelling system according to an aspect of the invention. The schematic diagram according to FIG. 3 shows a power supply PS connected to a motor M, the power supply being provided with power from a power source SRC and being controlled by control unit CON. The power supply PS comprises an energy storage element in this example super capacitor C. Although the operation of the circuit according to FIG. 3 is essentially identical to that of FIG. 2, contacts CNT are provided between the power source SRC and the power supply PS. As an example, the power source PS, motor M and control unit CON may be mounted in the passenger carrier of the amusement device. The passenger carrier may move in an area of movement. Depending on the position of the passenger carrier, contacts CNT of the power source SRC and of the passenger carrier may establish an electrical contact, thereby allowing the power source to charge the super capacitor. When moving away, the control unit may control the power supply such as to drive the motor M with energy stored in the super capacitor C. FIG. 3 shows a dotted line to symbolically distinguish a stationary part ST having the power source from a passenger carrier part PC, in this embodiment comprising the power supply, motor and controller. In an embodiment, a motor M may comprise a motor-generator combination (e.g. a motor acting as a generator) the control system controlling the power supply to charge the super capacitor with electrical energy generated by the generator during a motion of the passenger carrier. Thereby, energy may be regenerated, e.g. during a deceleration of the passenger carrier, thereby re-charging the super capacitor enabling the power supply, under control of the control unit, to power the motor M at a later moment in time with the energy stored in the super capacitor.

FIG. 4 depicts a highly schematic representation of a further embodiment of a propelling system according to the invention. Further, a power source SRC is depicted. Similarly to the embodiments described above, a power supply PS is provided to power a motor M, under control of a control unit CON the power supply PS may be provided with energy from a power SRC. The power supply PS in this embodiment further comprises a converter CV (which has been depicted in FIG. 4 as a separate entity), the converter to convert electrical power into a charging voltage for charging super capacitor C, and visa versa. The converter CV may comprise any type of converter, in a preferred embodiment a bi directional direct currrent-direct current converter is provided, to convert electrical power provided to it into a suitable charging voltage and charging current for charging the super capacitor, and to convert a discharging current/voltage of the super capacitor into a suitable voltage/current for the power supply. Thereby, a large range of operation of the super capacitor may be provided, as voltage levels of the power supply, the power source respectively the electric motor M may be converted by the converter CV into a suitable charging/discharging voltage. Any suitable type of direct currrent-direct current converter may be provided, in a preferred embodiment a switching direct currrent-direct current converter is provided allowing for a low loss conversion.

FIG. 5 A-C depict a parallel configuration, parallel/series configuration and a series configuration respectively of (super) capacitors contained in the energy storage element according to an embodiment of the invention. A converter having a switching network may be provided to switch the (super) capacitors such as to be in the configurations according to FIGS. 5A-5C. By such switching network (not shown), a wider operating voltage range may be obtained: when a charging voltage provided to the super capacitors low, the super capacitors may be connected in the configuration according to FIG. 5A, while the higher the charging voltage gets, first the converter switches to the configuration according to FIG. 5B, and then to the configuration according to FIG. 5C. Thereby, a larger charging voltage range may be handled by the super capacitors. It is to be understood that the embodiments in FIG. 5A-5C are for illustrative purposes only: in a practical implementation, use may be made of a more large amount of super capacitors, thereby providing possibilities for many series/parallel connections and combinations thereof.

FIG. 6 schematically indicates a further possible embodiment of the converter and energy storage element. In this embodiment, the converter comprises a conductor to form a resonance circuit with the (super) capacitor, a resonance frequency of the resonance circuit being adapted to an operation cycle time, e.g. a passenger carrier propelling time. Adaptation of the resonance frequency may take place by switching more or less capacitors to the energy storage element by means of a suitable switching network (not shown) to thereby alter a total capacitance value.

1. An amusement device having a passenger carrier and a propelling system for propelling the passenger carrier, the propelling system comprising an electric motor to propel the passenger carrier, a power supply to power the electric motor, the power supply comprising an electrical storage element to store electrical energy, and a control unit which is arranged to control operation of the power supply, the control unit being arranged to:
operate the power supply to charge the electrical storage element from an power source; and
operate the power supply to power the electric motor from the electrical energy stored in the electrical storage element, to thereby propel the passenger carrier.

2. The amusement device according to claim 1, wherein the electrical storage element comprises a capacitor, more preferably a super capacitor.

3. The amusement device according to claim 1, wherein the power supply comprises a converter to convert electrical power into a charging voltage for charging the storage element, and vice versa.

4. The amusement device according to claim 3, wherein the converter comprises a bidirectional direct current-direct current converter.

5. The amusement device according to claim 3, wherein the storage element comprises a plurality of capacitors and wherein the converter comprises a switching network to switch the capacitors in series—and/or parallel combinations.

6. The amusement device according to claim 3, wherein the storage element comprises the super capacitor and wherein the converter comprises an inductor to form an inductor-capacitor resonance circuit with the super capacitor, a resonance frequency of the resonance circuit being adapted to a propelling action time of the motor.

7. The amusement device according to claim 1, wherein the control unit is arranged to measure an operating voltage of the electrical storage element and to connect an electrical power dissipater when the operating voltage of the electrical storage element exceeds a maximum operating voltage.

8. The amusement device according to claim 1, wherein the propelling system is mounted in the passenger carrier, the motor comprising a motor-generator combination, the control system to control the power supply to charge the electrical storage element with electrical energy generated by the generator during a motion of the passenger carrier.

9. A propelling method for propelling a passenger carrier in an amusement device, wherein the passenger carrier is propelled by an electric motor, the electric motor being driven from an electrical storage element, the method comprising:
charging the electrical storage element from an power source; and
powering the electric motor from electrical energy stored in the electrical storage element, to thereby propel the passenger carrier

10. The amusement device according to claim 2 wherein the power supply comprises a converter to convert electrical power into a charging voltage for charging the storage element, and vice versa.

11. The amusement device according to claim 2, wherein the control unit is arranged to measure an operating voltage of the electrical storage element and to connect an electrical power dissipater when the operating voltage of the electrical storage element exceeds a maximum operating voltage.

12. The amusement device according to claim 3, wherein the control unit is arranged to measure an operating voltage of the electrical storage element and to connect an electrical power dissipater when the operating voltage of the electrical storage element exceeds a maximum operating voltage.

13. The amusement device according to claim 4, wherein the control unit is arranged to measure an operating voltage of the electrical storage element and to connect an electrical power dissipater when the operating voltage of the electrical storage element exceeds a maximum operating voltage.

14. The amusement device according to claim 5, wherein the control unit is arranged to measure an operating voltage of the electrical storage element and to connect an electrical power dissipater when the operating voltage of the electrical storage element exceeds a maximum operating voltage.

15. The amusement device according to claim 6, wherein the control unit is arranged to measure an operating voltage of the electrical storage element and to connect an electrical power dissipater when the operating voltage of the electrical storage element exceeds a maximum operating voltage.

16. The amusement device according to claim 2, wherein the propelling system is mounted in the passenger carrier, the motor comprising a motor-generator combination, the control system to control the power supply to charge the electrical storage element with electrical energy generated by the generator during a motion of the passenger carrier.

17. The amusement device according to claim 3, wherein the propelling system is mounted in the passenger carrier, the motor comprising a motor-generator combination, the control system to control the power supply to charge the electrical storage element with electrical energy generated by the generator during a motion of the passenger carrier.

18. The amusement device according to claim 4, wherein the propelling system is mounted in the passenger carrier, the motor comprising a motor-generator combination, the control system to control the power supply to charge the electrical storage element with electrical energy generated by the generator during a motion of the passenger carrier.

19. The amusement device according to claim 5, wherein the propelling system is mounted in the passenger carrier, the motor comprising a motor-generator combination, the control system to control the power supply to charge the electrical storage element with electrical energy generated by the generator during a motion of the passenger carrier.

20. The amusement device according to claim 6, wherein the propelling system is mounted in the passenger carrier, the motor comprising a motor-generator combination, the control system to control the power supply to charge the electrical storage element with electrical energy generated by the generator during a motion of the passenger carrier.
